(19) United States
(12) Patent Application Publication
(10) Pub. No.: US 2011/0089997 A1
(43) Pub. Date: Apr. 21, 2011

(54) POWER SUPPLY CIRCUIT

(75) Inventor: Fumio TONOMURA, Kanagawa (JP)

(73) Assignee: RENESAS ELECTRONICS CORPORATION, Kanagawa (JP)

(21) Appl. No.: 12/906,570

(22) Filed: Oct. 18, 2010

(30) Foreign Application Priority Data
Oct. 19, 2009 (JP) 2009-240604

(51) Int. Cl. G05F 3/02

(52) U.S. Cl. 327/536

(57) ABSTRACT

A power supply circuit in accordance with the invention includes a charge-pump circuit and a control circuit. The charge-pump circuit includes first and second capacitors. The control circuit controls the charging voltage of the first and second capacitors. In this way, the power supply circuit outputs a constant output voltage based on the charging voltages of the first and second capacitors.

### INCORPORATION BY REFERENCE

This application is based upon and claims the benefit of priority from Japanese patent application No. 2009-240604, filed on Oct. 19, 2009, the disclosure of which is incorporated herein in its entirety by reference.

### BACKGROUND

1. Field of the Invention

The present invention relates to a power supply circuit, in particular a power supply circuit that outputs a constant voltage.

2. Description of Related Art

Charge-pump-type power supply circuits using capacitors are used in antenna switch ICs (Integrated Circuits), liquid-crystal driver ICs, and the likes that are installed in mobile terminals such as mobile phones. This is because the charge-pump-type power supply circuits using capacitors have advantages including causing small noise and requiring a small number of external components.

Such power supply circuits are supplied with a battery voltage from a battery, and generate a desired voltage (for example, ±2.5 V) from the battery voltage. Therefore, it is desired that the power supply circuits can operate over a wide range from a state where the battery voltage is high (when the battery is fully charged, e.g., about 3.6 V) to a state where the battery voltage is low (when the battery is nearly exhausted, e.g., about 2 V). Further, since the power supply circuits are installed within antenna switch ICs and liquid-crystal driver ICs, it is also desired that they occupy as small area as possible.

Various configurations have been proposed for such charge-pump-type power supply circuits (Japanese Unexamined Patent Application Publication Nos. 2005-176513, 2007-202267, 2005-20922 and 2006-158132). The configuration and the operation of power supply circuits in accordance with Japanese Unexamined Patent Application Publication Nos. 2005-176513, 2007-202267, 2005-20922 and 2006-158132 are explained hereinafter with reference to drawings.

Firstly, the configuration of a power supply circuit in accordance with Japanese Unexamined Patent Application Publication No. 2005-176513 is explained. FIG. 6 is a circuit diagram of a power supply circuit 600 in accordance with Japanese Unexamined Patent Application Publication No. 2005-176513. The power supply circuit 600 is composed of a charge-pump circuit 61 and a regulator circuit 62. The charge-pump circuit 61 includes a voltage-boost capacitor C61, a smoothing capacitor C62, switches T61 to T64, and an inverter INV61. The switch T61, the voltage-boost capacitor C61, and the switch T62 are connected in series between a supply voltage Vbat61 and a ground. One end of the switch T63 is connected to the supply voltage Vbat61 and the other end is connected to the negative-side terminal of the voltage-boost capacitor C61. One end of the switch T64 is connected to the positive-side terminal of the voltage-boost capacitor C61 and the other end is connected to a voltage Vcp61. The smoothing capacitor C62 is connected between the voltage Vcp61 and the ground. A clock CLK 61 is input to the control terminals of the switches T61 and T62. The clock CLK 61 is also input to the inverter INV61, and the inverter INV61 outputs the inverted signal of the clock CLK 61 to the control terminals of the switches T63 and T64. The regulator circuit 62 includes an operation amplifier OPAMP61, resistors R61 and R62, and a smoothing capacitor C63. The voltage Vcp61 is connected to the operation amplifier OPAMP61 as a power supply. The output terminal of the operation amplifier OPAMP61 is connected to the resistor R61 and an output voltage Vout61. The resistor R62 is connected between the resistor R61 and the ground. The smoothing capacitor C63 is connected between the output voltage Vout61 and the ground. Further, a reference voltage Vr61 and a voltage between the resistors R61 and R62 are input to the operation amplifier OPAMP61.

Next, the operation of the power supply circuit 600 is explained. In the power supply circuit 600, when the clock CLK 61 is at a High level (charging period), the switches T61 and T62 are turned on and the switches T63 and T64 are turned off. As a result, the supply voltage Vbat61 is applied to the voltage-boost capacitor C61 and the voltage-boost capacitor C61 is thereby charged. On the other hand, when the clock CLK 61 is at a Low level (discharging period), the switches T61 and T62 are turned off and the switches T63 and T64 are turned on. As a result, a voltage (=Vbat61×2) obtained by adding the charging voltage of the voltage-boost capacitor C61 (=Vbat61) to the supply voltage Vbat61 is applied to the smoothing capacitor C62 and the smoothing capacitor C62 is thereby charged. The regulator circuit 62 generates an output voltage Vout61 (=(1+R61/R62)×Vr61) by using the voltage Vcp61 as a power supply.

In the power supply circuit 600, when Vbat61=2 V, Vr61=1.25 V, and R61/R62=1, for example, the voltage Vcp61 is expressed as “Vcp61=Vbat61×2=4 V”. Therefore, the voltage Vout61 is obtained as “Vout61=(1+R61/R62)×Vr61=2.5 V”. Further, when Vbat61=3.6 V, Vr61=1.25 V, and R61/R62=1, for example, the voltage Vcp61 is expressed as “Vcp61=Vbat61×2=7.2 V”. Therefore, the voltage Vout61 is obtained as “Vout61=(1+R61/R62)×Vr61=2.5 V”.

Next, a power supply circuit in accordance with Japanese Unexamined Patent Application Publication No. 2007-202267 is explained. FIG. 7 is a circuit diagram of a power supply circuit 700 in accordance with Japanese Unexamined Patent Application Publication No. 2007-202267. The power supply circuit 700 is composed of a charge-pump circuit 71 and a regulator circuit 72. The charge-pump circuit 71 is obtained by replacing the supply voltage Vbat61 of the charge-pump circuit 61 shown in FIG. 6 with a voltage Vreg71 output from the regulator circuit 72. Further, in the charge-pump circuit 71, the voltage Vcp61 of the charge-pump circuit 61 is replaced with an output voltage Vout71. The regulator circuit 72 is obtained by changing the power supply of the operation amplifier OPAMP61 from the voltage Vcp61 to a supply voltage Vbat71. The other configuration and operation are similar to those of the power supply circuit 600 shown in FIG. 6, and therefore their explanation is omitted.

In the power supply circuit 700, when Vbat71=2 V, Vr61=0.625 V, and R61/R62=1, for example, the voltage Vreg71 is expressed as “Vreg71=(1+R61/R62)×Vr61=1.25 V”. Therefore, the voltage Vout61 is obtained as “Vout61=Vreg71×2=2.5 V”. Further, when Vbat71=3.6 V, Vr61=0.625 V, and R61/R62=1, for example, the voltage Vreg71 is obtained as “Vreg71×2=2.5 V”.

Japanese Unexamined Patent Application Publication No. 2005-20922 proposes a power supply circuit that does not use any regulator (FIG. 1 of Japanese Unexamined Patent Application Publication No. 2005-20922). FIG. 8 is the circuit diagram of a power supply circuit 800 in accordance with Japanese Unexamined Patent Application Publication No. 2005-20922. The power supply circuit 800 is composed of a charge-pump circuit 81, a comparison circuit 82, and a control circuit 83. In the charge-pump circuit 81, the inverter INV61 of the charge-pump circuit 61 shown in FIG. 6 is moved into the control circuit 83 as an inverter INV81. Further, a voltage V81 between the switch T61 and the voltage-boost capacitor C61 is output to the comparison circuit 82. A signal output from the control circuit 83 is input to the control terminals of the switches T61 and T62. The other configuration is similar to that of the charge-pump circuit 61 shown in FIG. 6, and therefore its explanation is omitted. The comparison circuit 82 includes a comparator COMP81. The comparator COMP81 receives a reference voltage Vr81 and a voltage V81 output from the charge-pump circuit 81, and outputs an output V82 to the control circuit 83. The control circuit 83 includes an AND block AND81 and an inverter INV81. A clock CLK81 is input to the AND block AND81. Further, the output V82 is input to the AND block AND81 through a level shift LS81. Then, the AND block AND81 outputs a signal to the control terminals of the switches T61 and T62. The inverter INV81 receives the clock CLK81, and outputs the inverted signal of the clock CLK81 to the control terminals of the switches T63 and T64.

Next, the operation of the power supply circuit 800 is explained. In the power supply circuit 800, when the clock CLK81 is at a High level and the output V82 of the comparison circuit 82 is at a High level (charging period), the switches T61 and T62 are turned on and the switches T63 and T64 are turned off. As a result, the supply voltage Vbat61 is applied to the voltage-boost capacitor C61 and the voltage-boost capacitor C61 is thereby charged. On the other hand, when the clock CLK81 is at a Low level (discharging period), the switches T61 and T62 are turned off and the switches T63 and T64 are turned on. As a result, a voltage obtained by adding the voltage V81 to the supply voltage Vbat61 is applied to the smoothing capacitor C62 and the smoothing capacitor C62 is thereby charged. During the charging period, the voltage V81 is compared with the reference voltage Vr81 by the comparator COMP81. Then, when (voltage V81)<(reference voltage Vr81), a High level is output as the voltage V82. When (voltage V81)≧(reference voltage Vr81), a Low level is output as the voltage V82. On the other hand, when the output V82 of the comparator COMP81 is at a High level, the output of the AND block AND81 of the control circuit 83 becomes a High level and the charging is thereby continued. When the output V82 of the comparator COMP81 is at a Low level, the output of the AND block AND81 becomes a Low level and the charging is thereby stopped. In this way, the voltage V81 is charged to a voltage equal to the reference voltage Vr81. By repeating this process, an output voltage Vout61 (=Vbat61+V81) is generated.

In the power supply circuit 800, when Vbat61=2 V and Vr81=0.5 V, for example, the voltage-boost capacitor C61 is charged to 0.5 V. This is because, in the range of V81≧0.5 V in the charging period, the output of the comparator COMP81 is changed from a High level to a Low level and the charging to the voltage-boost capacitor C61 is thereby stopped. As a result, the voltage Vout61 is obtained as “Vout61=Vbat61+0.5V=2.5 V”. Further, when Vbat61=1.25 V and Vr81=1.25 V, for example, the voltage-boost capacitor C61 is charged to 1.25 V. As a result, the voltage Vout61 is obtained as “Vout61=Vbat61+1.25V=2.5 V”.

Further, Japanese Unexamined Patent Application Publication No. 2006-158132 discloses a power supply circuit composed of charge-pump circuits connected in two stages and a selection signal generation circuit (FIG. 1 of Japanese Unexamined Patent Application Publication No. 2006-158132). In this power supply circuit, the first-stage charge pump increases a supply voltage by a factor of two. Further, the selection signal generation circuit monitors the supply voltage. The second-stage charge pump further increases the voltage that is obtained by increasing the supply voltage by a factor of two by the first-stage charge pump to generate a voltage higher than the supply voltage by a factor of three or four. That is, this power supply circuit increases the supply voltage by a factor of four when the supply voltage is lower than a predetermined value, and increases the supply voltage by a factor of three when the supply voltage is higher than the predetermined value. In this way, it is possible to limit the maximum voltage applied to this power supply circuit and thereby to reduce the maximum withstand voltage required for the components used in the power supply circuit.

### SUMMARY

The present inventors have found a following problem. In the power supply circuit 600 shown in FIG. 6, when the voltage Vout61 expressed as “Vout61=2.5 V” is to be obtained in the range of “2V≦Vbat61≦3.6 V”, the voltage Vcp61 is expressed as “4V≦Vcp61≦7.2 V” as described above. Therefore, as the supply voltage increases, the power-supply voltage of the regulator circuit increases to a level higher than necessary. As a result, the power consumption increases. Further, since the power supply circuit requires the regular circuit, the scale of circuit is comparatively large. Therefore, this power supply circuit is inappropriate when the reduction in size is desired.

In the power supply circuit 700 shown in FIG. 7, another problem occurs when the supply voltage is further decreased. For example, when the voltage Vout71 expressed as “Vout71=2.5 V” is to be obtained with a condition of Vbat71=1.5V, the voltage difference between the voltage Vreg71 (=1.25 V) output from the regulator circuit 72 and the supply voltage Vbat71 (=1.5 V) becomes zero. As a result, it causes another problem that the voltage Vreg71 expressed as “Vreg71=1.25 V” cannot be obtained. Further, the power supply circuit 700 also requires the regulator circuit as with the power supply circuit 600 shown in FIG. 6. Therefore, the scale of circuit is comparatively large, thus making the power supply circuit inappropriate when the reduction in size is desired.

In the power supply circuit 800 shown in FIG. 8, assume a case where the supply voltage Vbat61 is expressed as “Vbat61=3.6 V”. In this case, even if the voltage charged to the voltage-boost capacitor C61 is 0 V, the output voltage Vout61 is expressed as “Vout61=3.6 V”. Therefore, the desired voltage 2.5 V cannot be obtained. That is, there is a problem in the power supply circuit 800 that, letting Vout stand for the desired voltage, the power supply circuit 800 can operate properly only in the range of Vout/2≦Vbat61≦Vout. Further, to maintain the output voltage Vout61 at a constant voltage irrespective of the change in the supply voltage Vbat61, it is necessary to change the reference voltage Vr81.

In the power supply circuit disclosed in Japanese Unexamined Patent Application Publication No. 2006-158132, the supply voltage is simply increased by a factor of three or four. As a result, the output voltage fluctuates according to the supply voltage. Therefore, the power supply circuit cannot be used as a stable power supply.

A first exemplary aspect of the present invention is a power supply circuit including: a charge-pump circuit including first and second capacitors; and a control circuit that controls a charging voltage of the first and second capacitors, wherein the power supply circuit outputs a constant output voltage based on a charging voltage of the first capacitor and a charging voltage of the second capacitor.

The above-described power supply circuit includes two capacitors whose charging voltages are controlled. In this way, even if the voltage used to charge one of the capacitors is insufficient for a desired output voltage, the desired voltage is generated by adding the charging voltage of the other capacitor. In this way, even if the supply voltage fluctuates over a wide range, a constant output voltage can be obtained.

The present invention can provide a power supply circuit capable of providing a constant output voltage even when the supply voltage fluctuates over a wide range, and capable of being reduced in size.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram of a power supply circuit in accordance with a first exemplary embodiment of the present invention;

FIG. 2 is a graph showing an operation of a power supply circuit in accordance with a first exemplary embodiment of the present invention;

FIG. 3 is a graph showing an operation of a power supply circuit in accordance with a first exemplary embodiment of the present invention;

FIG. 4 is a circuit diagram of a power supply circuit in accordance with a second exemplary embodiment of the present invention;

FIG. 5 is a circuit diagram of a power supply circuit in accordance with a comparative example 1;

FIG. 6 is a circuit diagram of a power supply circuit disclosed in Japanese Unexamined Patent Application Publication No. 2005-176513;

FIG. 7 is a circuit diagram of a power supply circuit disclosed in Japanese Unexamined Patent Application Publication No. 2007-202267; and

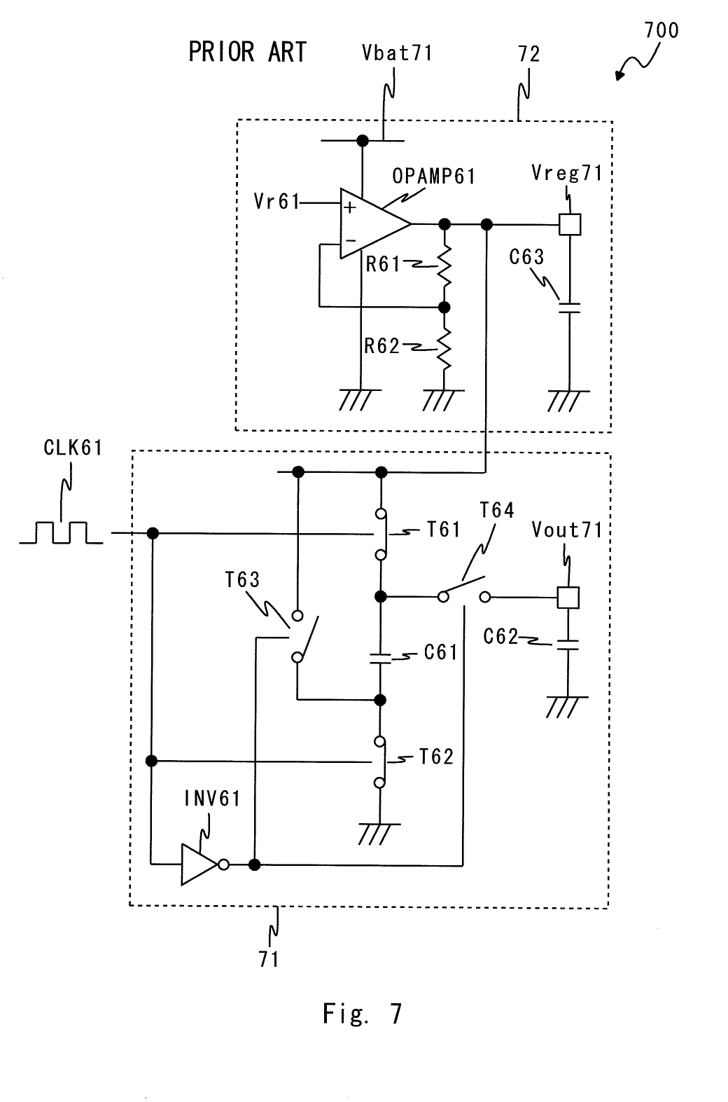

FIG. 8 is a circuit diagram of a power supply circuit disclosed in Japanese Unexamined Patent Application Publication No. 2005-20922.

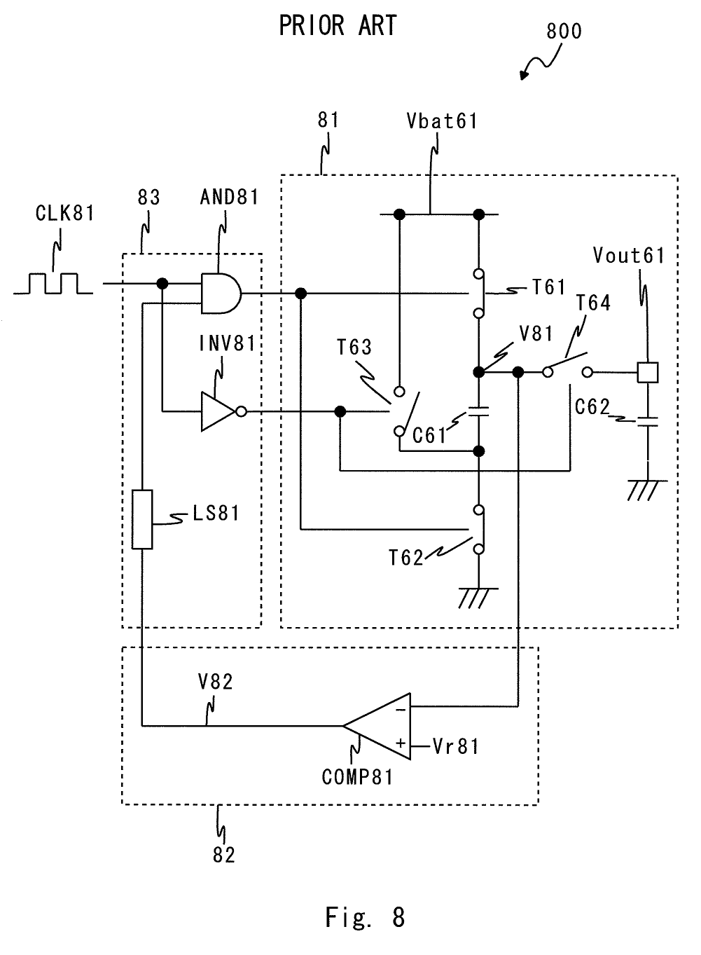

### DETAILED DESCRIPTION OF THE EXEMPLARY EMBODIMENTS

Exemplary embodiments in accordance with the present invention are explained hereinafter with reference to the drawings.

### First Exemplary Embodiment

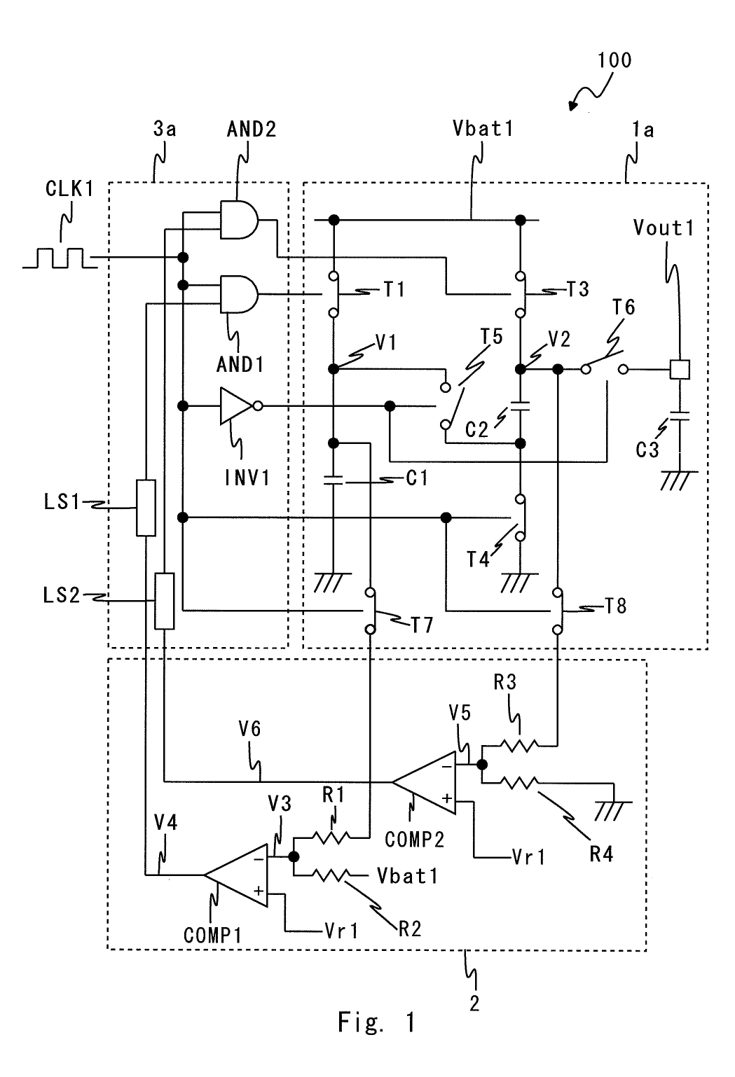

Firstly, a power supply circuit in accordance with a first exemplary embodiment of the present invention is explained. FIG. 1 is a circuit diagram of a power supply circuit 100 in accordance with a first exemplary embodiment of the present invention. The power supply circuit 100 includes a charge-pump circuit 1a, a comparison operation circuit 2, and a switch control circuit 3a.

The charge-pump circuit 1a includes a switch T1, switches T3 to T8, a voltage-boost capacitor C1, a voltage-boost capacitor C2, and a smoothing capacitor C3. The switch T1 and the voltage-boost capacitor C1 are connected in series between a supply voltage Vbat1 and a ground. Further, the switch T3, the voltage-boost capacitor C2, and the switch T4 are also connected in series between the supply voltage Vbat1 and the ground. The switch T5 is connected between the positive-side terminal of the voltage-boost capacitor C1 and the negative-side terminal of the voltage-boost capacitor C2. The switch T6 is connected between the positive-side terminal of the voltage-boost capacitor C2 and an output voltage Vout1. The smoothing capacitor C3 is connected between the output voltage Vout1 and the ground. The switch T7 is connected between the positive-side terminal of the voltage-boost capacitor C1 and the comparison operation circuit 2. The switch T8 is connected between the positive-side terminal of the voltage-boost capacitor C2 and the comparison operation circuit 2. Further, the control terminals of the switches T1, T3, T5 and T6 are connected to the switch control circuit 3a. A clock CLK1 is input to the control terminals of the switches T4, T7 and T8. Note that, in this example, the voltage at the positive-side terminal of the voltage-boost capacitor C1 is defined as “voltage V1” and the voltage at the positive-side terminal of the voltage-boost capacitor C2 is defined as “voltage V2”.

The comparison operation circuit 2 includes resistors R1 to R4 and comparators COMP1 and COMP2. One of the input terminals of the comparator COMP1 is connected to one ends of the resistors R1 and R2 and the other input terminal is connected to a reference voltage Vr1. The other end of the resistor R1 is connected to the switch T7. The other end of the resistor R2 is connected to the supply voltage Vbat1. One of the input terminals of the comparator COMP2 is connected to one ends of the resistors R3 and R4 and the other input terminal is connected to the reference voltage Vr1. The other end of the resistor R3 is connected to the switch T8. The other end of the resistor R4 is connected to the ground. The comparator COMP1 outputs an output V4 to the switch control circuit 3a and the comparator COMP2 outputs an output V6 to the switch control circuit 3a. Note that the resistors R1 to R4 have relations “R1=R2” and “R3=R4”.

The switch control circuit 3a includes an AND block AND1, an AND block AND2, and an inverter INV1. The AND block AND1 receives the clock CLK1, also receives the output V4 through a level shift LS1, and outputs a signal to the control terminal of the switch T1. The AND block AND2 receives the clock CLK1, also receives the output V6 through a level shift LS2, and outputs a signal to the control terminal of the switch T3. The inverter INV1 receives the clock CLK1 and outputs the inverted signal of the clock CLK1 to the switches T5 and T6.

Next, an operation of the power supply circuit 100 is explained. In the power supply circuit 100, when the clock CLK1 is at a High level and the two outputs of the comparison operation circuit 2 (outputs V4 and V6) are at a High level, the outputs of the AND blocks AND1 and AND2 become a High level. As a result, the switches T1, T3 and T4 are turned on, and the switches T5 and T6 are turned off. Therefore, the supply voltage Vbat1 is supplied to the voltage-boost capacitors C1 and C2 (charging period). On the other hand, when the clock CLK1 is at a Low level, the switches T1, T3 and T4 are turned off, and the switches T5 and T6 are turned on. As a result, the sum of the voltages charged in the voltage-boost capacitors C1 and C2 is charged to the smoothing capacitor C3 (discharging period). By repeating these charging period and discharging period, an output voltage Vout1 is generated.

While defining the desired output voltage of the power supply circuit 100 as “output voltage Vout”, a case of Vr1=Vout/2 is discussed below as an example. During the charging period, a voltage V1 charged in the voltage-boost capacitor C1 is applied to the resistor R1 through the switch T7.

At this point, since R1=R2, a voltage V3 at the connection point between the resistors R1 and R2 is expressed by the following equation (1).

V3=(V1+Vbat1)/2 (1)

When V3<Vr1, the output V4 of the comparator COMP1 becomes a High level and is input to the AND block AND1 through the level shift LS1. As a result, the output of the AND block AND1 becomes a High level and the charging to the voltage-boost capacitor C1 is thereby continued.

When V3≧Vr1, the output V4 of the comparator COMP1 becomes a Low level and is input to the AND block AND1 through the level shift LS1. As a result, the output of the AND block AND1 becomes a Low level. Therefore, the switch T1 is turned off and the charging to the voltage-boost capacitor C1 is thereby stopped. At this point, the charging voltage of the voltage-boost capacitor C1 is expressed by the following equations (2) and (3).

Vr1=Vout/2=V3=(V1+Vbat1)/2 (2)

V1=Vout−Vbat1 (3)

Therefore, when Vout>Vbat1, the voltage-boost capacitor C1 is charged to a differential voltage (Vout−Vbat1) between the desired voltage and the supply voltage. On the other hand, when Vout≦Vbat1, the relation “V3≧Vr1” holds from immediately after the start of the operation (V1=0 V). Therefore, the output V4 becomes a Low level and the switch T1 is thereby turned off. Therefore, the voltage-boost capacitor C1 is not charged.

Further, during the charging period, a voltage V2 charged in the voltage-boost capacitor C2 is applied to the resistor R3 through the switch T8. Since R3=R4, a voltage V5 at the connection point between the resistors R3 and R4 is expressed by the following equation (4).

V5=V2/2 (4)

When V5<Vr1, the output V6 of the comparator COMP2 becomes a High level and is input to the AND block AND2 through the level shift LS2. As a result, the output of the AND block AND2 becomes a High level and the charging to the voltage-boost capacitor C2 is thereby continued.

When V5≧Vr1, the output V6 of the comparator COMP2 becomes a Low level and is input to the AND block AND2 through the level shift LS2. As a result, the output of the AND block AND2 becomes a Low level. Therefore, the switch T3 is turned off and the charging to the voltage-boost capacitor C2 is thereby stopped. At this point, the charging voltage of the voltage-boost capacitor C2 is expressed by the following equations (5) and (6).

Vr1=Vout/2=V5=V2/2 (5)

V2=Vout (6)

Therefore, when Vout>Vbat1, the relation “V5<Vr1” always holds. Therefore, the output V6 is always at a High level. Consequently, the voltage-boost capacitor C2 is charged throughout the charging period and its charging voltage becomes the supply voltage Vbat1. On the other hand, when Vout≦Vbat1, the voltage-boost capacitor C2 is charged to the desired voltage Vout1.

On the other hand, during the discharging period, the sum of the charging voltage (V1) of the voltage-boost capacitor C1 and the charging voltage (V2) of the voltage-boost capacitor C2 is applied to the smoothing capacitor C3. By repeating this process, the output voltage Vout1 becomes the desired output voltage Vout.

That is, when Vout≦Vbat1, the output voltage Vout1 is expressed by the following equation (7).

Vout1=0+Vout=Vout (7)

Further, when Vout>Vbat1, the output voltage Vout1 is expressed by the following equation (8).

Vout1=Vout−Vbat1+Vbat1=Vout (8)

(on condition that Vout/2≦Vbat1)

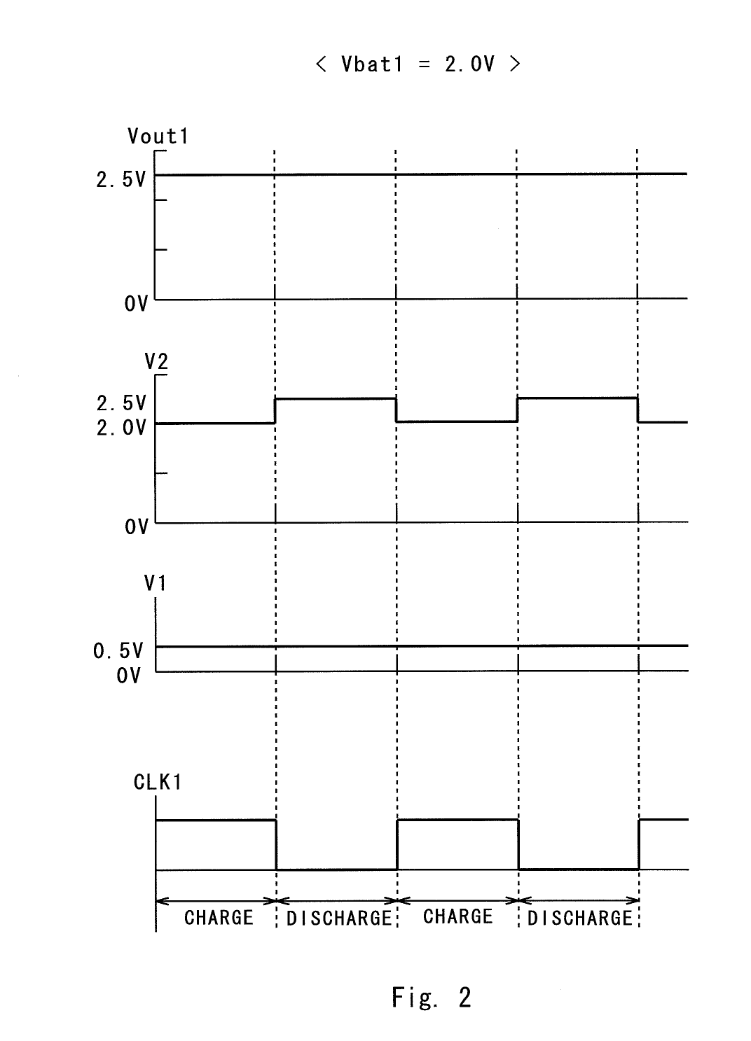

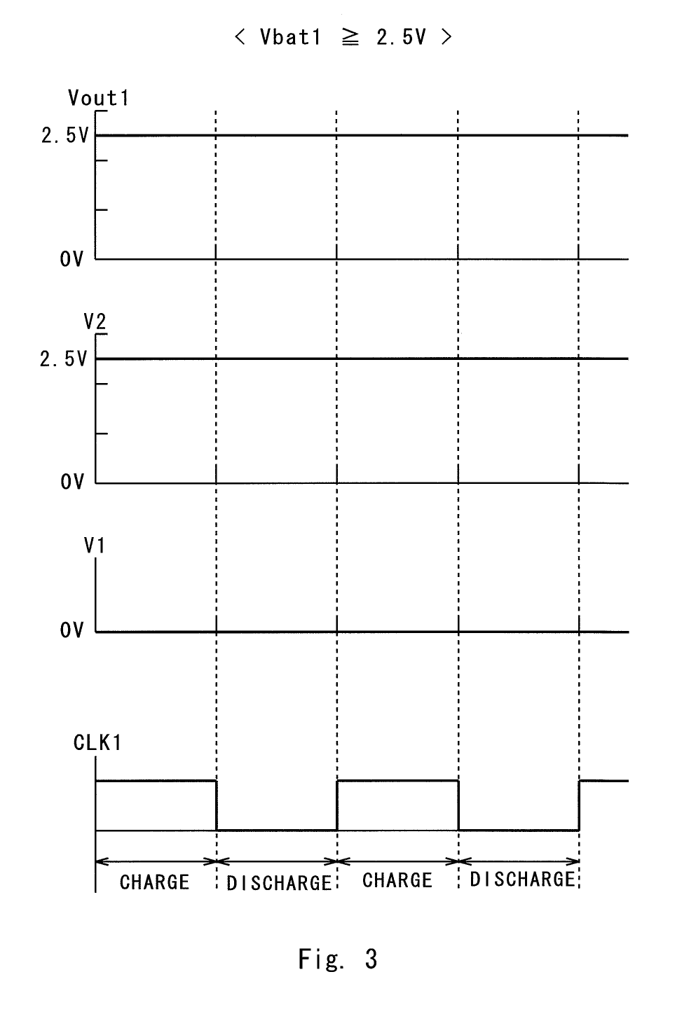

FIGS. 2 and 3 are graphs showing an operation of the power supply circuit 100. FIGS. 2 and 3 are drawn on an exemplary assumption that Vout=2.5 V and Vr1=1.25 V. Further, FIG. 2 shows a case of Vbat1=2 V, and FIG. 3 shows a case of Vbat1≧2.5 V. In FIG. 2, the voltage Vout1 is expressed as “Vout1=0.5 V+2.0 V=2.5 V”. In FIG. 3, the voltage Vout1 is expressed as “Vout1=0V+2.5 V=2.5 V”. Therefore, the voltage Vout1 is obtained as “Vout1=2.5 V” in both of the cases.

That is, in the power supply circuit 100, the control circuit (corresponding to comparison operation circuit 2 and switch control circuit 3a of FIG. 1) functions so as to control the charging voltage of the two voltage-boost capacitors of the charge-pump circuit (voltage-boost capacitor C1 and voltage-boost capacitor C2 of FIG. 1). With these two voltage-boost capacitors, even if the voltage used to charge one of the voltage-boost capacitors is insufficient for a desired output voltage, the desired voltage is generated by adding the charging voltage of the other voltage-boost capacitor.

Therefore, in accordance with this configuration, a constant output voltage can be always obtained as long as the supply voltage is equal to or higher than the half of the desired voltage. That is, it is possible to realize a power supply circuit that can provide a constant output voltage even when the supply voltage fluctuates over a wide range. Further, there is no need to switch the circuit according to the change in the supply voltage. Further, since no regulator circuit is used, the circuit scale can be reduced.

Furthermore, although an example where two voltage-boost capacitors are provided in the power supply circuit 100 is explained, the number of the voltage-boost capacitors is not limited to two. That is, in this power supply circuit, other configurations where n voltage-boost capacitors (n is an integer equal to or greater than three) are provided and a desired output voltage is generated by adding the charging voltage of each of the voltage-boost capacitors may be also employed. In such cases, the power supply circuit can be operated over a wide range as long as the supply voltage is equal to or higher than 1/n of the desired voltage.

### Second Exemplary Embodiment

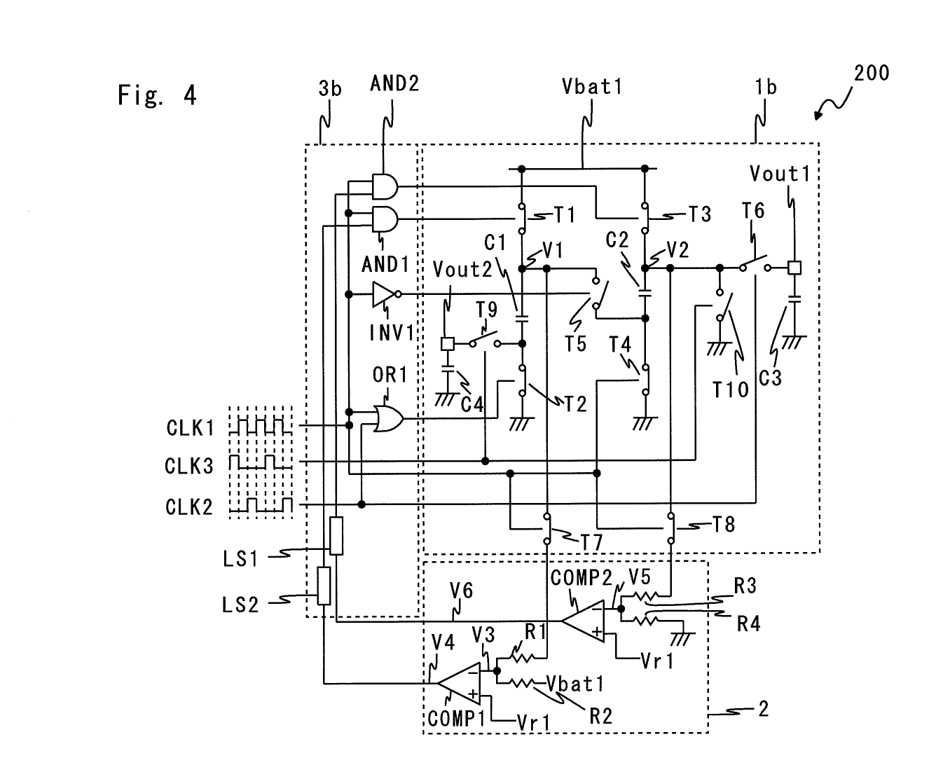

Next, a configuration of a power supply circuit in accordance with a second exemplary embodiment of the present invention is explained. FIG. 4 is a circuit diagram showing a configuration of a power supply circuit 200 in accordance with a second exemplary embodiment of the present invention. The power supply circuit 200 includes a charge-pump circuit 1b, a comparison operation circuit 2, and a switch control circuit 3b.

The charge-pump circuit 1b further includes a switch T2, a switch T9, a switch T10, an output voltage Vout2, and a smoothing capacitor C4 in comparison to that shown in FIG. 1. The switch T2 is connected between the voltage-boost capacitor C1 and the ground. One end of the switch T9 is connected to the negative-side terminal of the voltage-boost capacitor C1 and the other end is connected to the output voltage Vout2. One end of the switch T10 is connected to the positive-side terminal of the voltage-boost capacitor C2 and the other end is connected to the ground. The smoothing capacitor C4 is connected between the output voltage Vout2 and the ground. The control terminal of the switch T2 is connected to the switch control circuit 3b. A clock CLK2 is input to the control terminal of the switch T6, and a clock CLK3 is input to the control terminals of the switch T9 and switch T10. The other configuration is similar to that of the charge-pump circuit 1a shown in FIG. 1, and therefore its explanation is omitted.

The comparison operation circuit 2 is similar to that shown in FIG. 1, and therefore its explanation is omitted.

The switch control circuit 3b includes an additional OR block OR1 in comparison to that shown in FIG. 1. The OR block OR1 receives the clocks CLK1 and CLK2, and outputs a signal to the control terminal of the switch T2. The other configuration is similar to that of the switch control circuit 3a shown in FIG. 1, and therefore its explanation is omitted.

Next, an operation of the power supply circuit 200 is explained. In the power supply circuit 200, when the clocks CLK1, CLK2 and CLK3 are at High, Low and Low levels, respectively, and the two outputs of the comparison operation circuit 2 (outputs V4 and V6) are both at a High level, the outputs of the AND blocks AND1 and AND2 and the OR block OR1 become a High level. As a result, the switches T1, T2, T3 and T4 are turned on, and the switches T5, T6, T9 and T10 are turned off. Therefore, the supply voltage Vbat1 is supplied to the voltage-boost capacitors C1 and C2 (charging period).

At the next timing, when the clocks CLK1 and CLK3 become a Low level and the clock CLK2 becomes a High level, the switches T1, T3, T4, T9 and T10 are turned off and the switches T2, T5 and T6 are turned on. As a result, the sum of the voltages charged in the voltage-boost capacitors C1 and C2 is applied to the smoothing capacitor C3 (discharging period 1).

At the next timing, when the clock CLK1 becomes a High level and the clocks CLK2 and CLK3 become a Low level, the power supply circuit changes to a charging period again.

At the next timing, when the clocks CLK1 and CLK2 become a Low level and the clock CLK3 becomes a High level, the switches T1, T2, T3, T4 and T6 are turned off and the switches T5, T9 and T10 are turned on. As a result, the inverted voltage of the sum of the voltages charged in the voltage-boost capacitors C1 and C2 is applied to the smoothing capacitor C4 (discharging period 2).

By repeating the cycle of the above-described charging period, discharging period 1, charging period, and discharging period 2, an output voltage Vout1 and an output voltage Vout2 are generated. As described above, the output voltage Vout2 becomes the inverted voltage of the output voltage Vout1.

While defining the desired output voltage of the power supply circuit 200 as “output voltage Vout”, a case of Vr1=Vout/2 is discussed below as an example. During the charging period, a voltage V1 charged in the voltage-boost capacitor C1 is applied to the resistor R1 through the switch T7. Similarly to the first exemplary embodiment, the charging voltage is controlled, so that the charging voltage of the voltage-boost capacitor C1 is expressed by the above-described equation (3).

Therefore, similarly to the first exemplary embodiment, when Vout>Vbat1, the voltage-boost capacitor C1 is charged to a differential voltage (Vout−Vbat1) between the desired voltage and the supply voltage. On the other hand, when Vout≦Vbat1, the voltage-boost capacitor C1 is not charged.

Further, during the charging period, a voltage V2 charged in the voltage-boost capacitor C2 is applied to the resistor R3 through the switch T8. At this point, the charging voltage of the voltage-boost capacitor C2 is expressed by the above-described equation (6).

Therefore, similarly to the first exemplary embodiment, when Vout>Vbat1, the voltage-boost capacitor C2 is charged to the voltage Vbat1. On the other hand, when Vout≦Vbat1, the voltage-boost capacitor C2 is charged to the desired voltage Vout.

In the discharging period 1, similarly to the first exemplary embodiment, the output voltage Vout1 becomes the desired output voltage Vout. When Vout≦Vbat1, the voltage Vout1 is expressed by the above-described equation (7). When Vout>Vbat1, the voltage Vout1 is expressed by the above-described equation (8).

In the discharging period 2, the connection is reversed to that in the discharging period 1. Therefore, when Vout≦Vbat1, the voltage Vout2 is expressed by the following equation (9).

Vout2=−0−Vout=−Vout (9)

Further, when Vout1>Vbat1, the voltage Vout2 is expressed by the following equation (10).

Vout2=−(Vout−Vbat1)−Vbat1=−Vout (10)

(on condition that Vout/2≦Vbat1)

That is, the power supply circuit 200 can provide a similar output voltage to that of the power supply circuit 100 shown in FIG. 1. Further, the inverted output voltage of the desired output voltage can be also obtained.

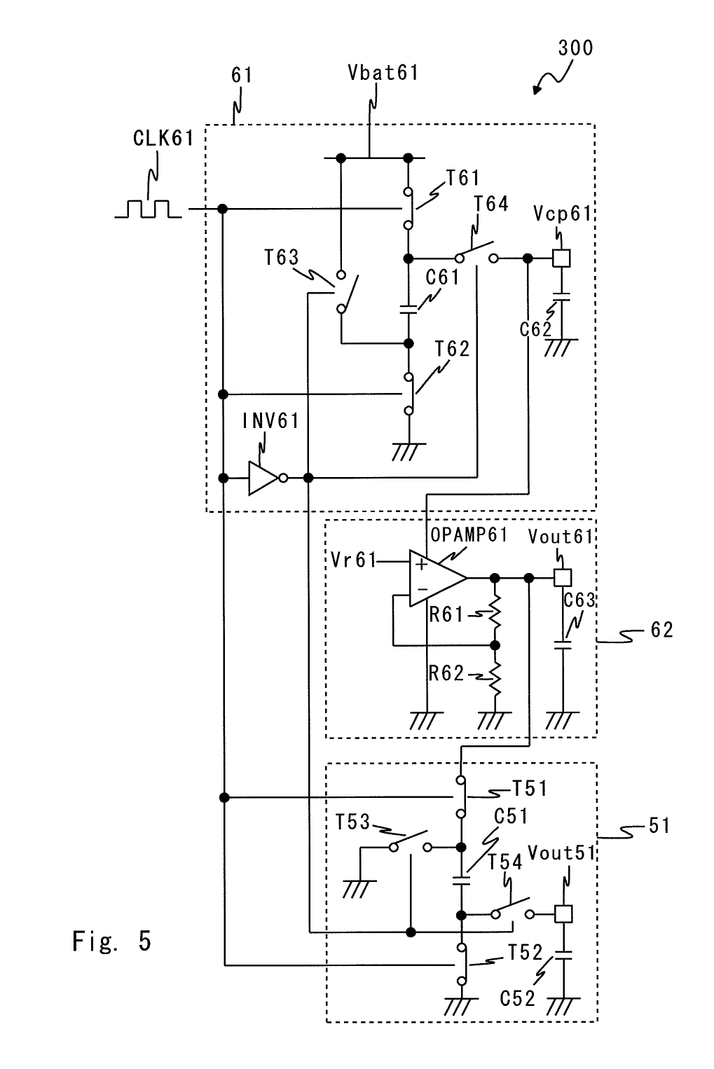

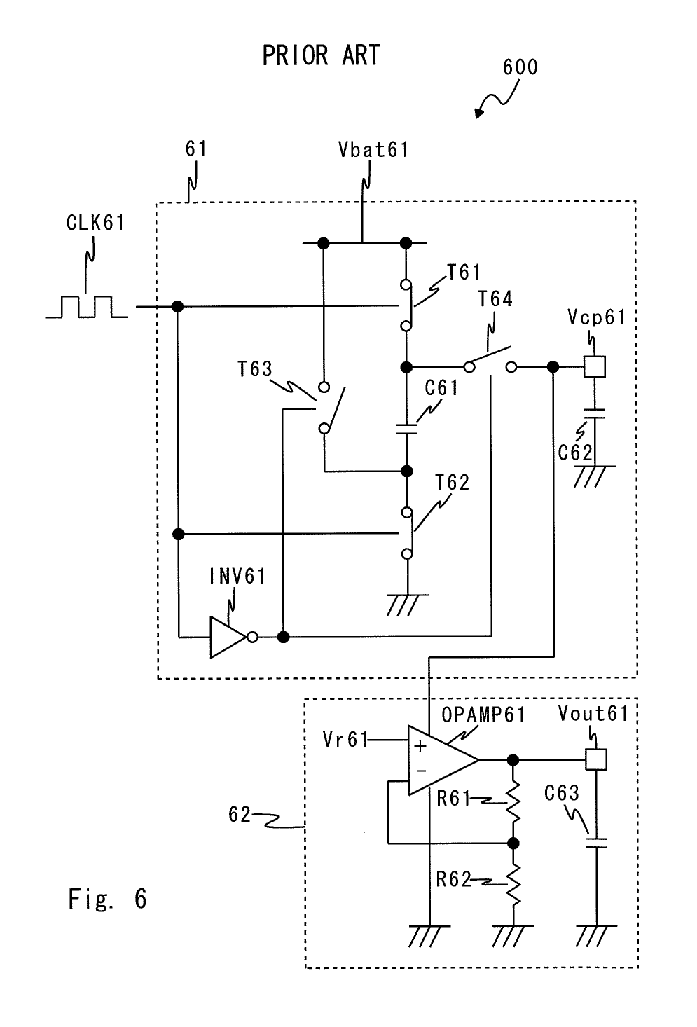

Furthermore, in accordance with this configuration, the number of external components as well as the number of terminals can be reduced. The number of external components in this configuration is four capacitors (the number of terminals is eight). In contrast to this, to obtain a similar output voltage to that of the power supply circuit 200 by using the power supply circuit 600 shown in FIG. 6, it is necessary to form a power supply circuit shown in FIG. 5, which is described below. In the power supply circuit shown in FIG. 5, the number of external components is five capacitors (the number of terminals is ten). Therefore, in accordance with the configuration of the exemplary embodiment, since the number of external components can be reduced, it is advantageous in terms of the reduction in size and in costs of the power supply circuit.

Furthermore, although an example where two voltage-boost capacitors are provided in the power supply circuit 200 is explained, the number of the voltage-boost capacitors is not limited to two as in the case of the power supply circuit 100 shown in FIG. 1. That is, in this power supply circuit, other configurations where n voltage-boost capacitors (n is an integer equal to or greater than three) are provided and a desired output voltage is generated by adding the charging voltage of each of the voltage-boost capacitors may be also employed. In such cases, the power supply circuit can be operated over a wide range as long as the supply voltage is equal to or higher than 1/n of the desired voltage.

### Comparative Example 1

Hereinafter, a comparative example to the power supply circuit 200 in accordance with the second exemplary embodiment is shown, and, with that, a supplemental explanation is made to explain an advantageous effect of the reduction of the number of capacitors to be disposed that is achieved by the power supply circuit 200. The power supply circuit in accordance with the comparative example 1 is a power supply circuit that can operate even in the condition of “(desired voltage/2)≦supply voltage” by using the power supply circuit 600 shown in FIG. 6. FIG. 5 is a circuit diagram of a power supply circuit 300 in accordance with the comparative example 1. The power supply circuit 300 includes a charge-pump circuit 61, a regulator circuit 62, and a charge-pump circuit 51. Note that the charge-pump circuit 61 and the regulator circuit 62 have similar configurations as those of the previously-explained power supply circuit 600 shown in FIG. 6, and therefore their explanation is omitted.

In the charge-pump circuit 51, a switch T51, a voltage-boost capacitor C51, and a switch T52 are connected in series between an output voltage Vout61 generated in the regulator circuit 62 and a ground. One end of the switch T53 is connected to the positive-side terminal of the voltage-boost capacitor C51 and the other end is connected to the ground. One end of the switch T54 is connected to the negative-side terminal of the voltage-boost capacitor C51 and the other end is connected to the output voltage Vout51. The smoothing capacitor C52 is connected between the output voltage Vout51 and the ground. A clock CLK 61 is input to the control terminals of the switches T51 and T52. The inverted signal of the clock CLK 61 that is supplied from an inverter INV61 is input to the control terminals of the switches T53 and T54.

Next, an operation of the power supply circuit 300 is explained. Note that the charge-pump circuit 61 and the regulator circuit 62 perform similar operations to those of the power supply circuit 600, and therefore their explanation is omitted. That is, the following explanation is made while focusing attention on the operation of the charge-pump circuit 51. In the charge-pump circuit 51, when the clock CLK 61 is at a High level, the switches T51 and T52 are turned on and the switches T53 and T54 are turned off. As a result, the voltage-boost capacitor C51 is charged to the output voltage Vout61 (charging period).

When the clock CLK 61 is at a Low level, the switches T51 and T52 are turned off and the switches T53 and T54 are turned on. As a result, the inverted voltage of the output voltage Vout61 charged in the voltage-boost capacitor C51 is output as an output voltage Vout51 (discharging period).

That is, in accordance with this configuration, the inverted voltage of the desired output voltage as well as the desired output voltage can be simultaneously output as in the case of the power supply circuit 200 shown in FIG. 4.

However, in this configuration, five capacitors, i.e., five external components are required. Therefore, a larger number of components are necessary in comparison to the power supply circuit 200 shown in FIG. 4. In addition, since the power supply circuit 300 includes the additional charge-pump circuit as well as the regulator circuit, the circuit scale becomes larger.

Accordingly, the number of capacitors to be disposed in the power supply circuit 300 is larger than that of the power supply circuit 200 by one. That is, in accordance with the power supply circuit 200, the number of capacitors to be disposed can be reduced in comparison to the conventional power supply circuit.

Note that the present invention is not limited to the above-described exemplary embodiments, and various modifications can be made without departing from the spirit and scope of the present invention.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A power supply circuit comprising:
a charge-pump circuit comprising first and second capacitors; and
a control circuit that controls a charging voltage of the first and second capacitors,
wherein the power supply circuit outputs a constant output voltage based on a charging voltage of the first capacitor and a charging voltage of the second capacitor.

2. The power supply circuit according to claim 1, wherein
the charge-pump circuit is supplied with a supply voltage, and
when the supply voltage is lower than the output voltage, a charging voltage of the first capacitor and a charging voltage of the second capacitor are added to output the output voltage.

3. The power supply circuit according to claim 2, wherein
the first capacitor is charged to a differential voltage between the output voltage and the supply voltage, and
the second capacitor is charged to the supply voltage.

4. The power supply circuit according to claim 2, wherein when the supply voltage is equal to or higher than the output voltage,
either one of the first capacitor and the second capacitor is charged to the output voltage, and
a charging voltage of the charged first capacitor or second capacitor is output as the output voltage.

5. The power supply circuit according to claim 1,
wherein the charge-pump circuit further comprises:
a first switch that controls a charging voltage of the first capacitor; and
a second switch that controls a charging voltage of the second capacitor, and
wherein the control circuit controls a charging voltage of the first capacitor by controlling opening/closing of the first switch, and
the control circuit controls a charging voltage of the second capacitor by controlling opening/closing of the second switch.

6. The power supply circuit according to claim 5, wherein when the supply voltage is lower than the output voltage,
the first switch is closed so that charging of the first capacitor is started, and
the second switch is closed so that charging of the second capacitor is started,
when a charging voltage of the first capacitor reaches a differential voltage between the output voltage and the supply voltage, the first switch is opened so that the charging of the first capacitor is stopped, and
the second capacitor is charged to the supply voltage.

7. The power supply circuit according to claim 5, wherein when the supply voltage is equal to or higher than the output voltage,
the first switch is opened so that the first capacitor is not charged,
the second switch is closed so that charging of the second capacitor is started, and
when a charging voltage of the second capacitor reaches the output voltage, the second switch is opened so that the charging of the second capacitor is stopped.

8. The power supply circuit according to claim 1, further comprising a third switch connected between a first positive-side terminal and a second negative-side terminal, the first positive-side terminal being a positive-side terminal of the first capacitor, the second negative-side terminal being a negative-side terminal of the second capacitor, and the third switch being controlled by the control circuit, wherein
a first negative-side terminal or a second positive-side terminal is connected to a ground, the first negative-side terminal being a negative-side terminal of the first capacitor, and the second positive-side terminal being a positive-side terminal of the second capacitor,
the first positive-side terminal is connected to the second negative-side terminal by closing the third switch,
when the first negative-side terminal is connected to the ground, a voltage at the second positive-side terminal becomes the output voltage, and
when the second positive-side terminal is connected to the ground, a voltage at the first negative-side terminal becomes an inverted voltage of the output voltage.

9. The power supply circuit according to claim 8,
wherein the charge-pump circuit further comprises:
a third capacitor connected between the first negative-side terminal and the ground; and
a fourth capacitor connected between the second positive-side terminal and the ground, and
wherein two voltages are output from the first negative-side terminal and the second positive-side terminal, the two voltages having same magnitude as the output voltage and being inverted to each other.

10. The power supply circuit according to claim 1, further comprising a fourth switch connected between a first negative-side terminal and a second positive-side terminal, the first negative-side terminal being a negative-side terminal of the first capacitor, the second positive-side terminal being a positive-side terminal of the second capacitor, and the fourth switch being controlled by the control circuit, wherein
a first positive-side terminal or a second negative-side terminal is connected to a ground, the first positive-side terminal being a positive-side terminal of the first capacitor, and the second negative-side terminal being a negative-side terminal of the second capacitor,
the first negative-side terminal is connected to the second positive-side terminal by closing the fourth switch,
when the first positive-side terminal is connected to the ground, a voltage at the second negative-side terminal becomes an inverted voltage of the output voltage, and
when the second negative-side terminal is connected to the ground, a voltage at the first positive-side terminal becomes the output voltage.

11. The power supply circuit according to claim 10,
wherein the charge-pump circuit further comprises:
a fifth capacitor connected between the first positive-side terminal and the ground; and
a sixth capacitor connected between the second negative-side terminal and the ground, and
wherein two voltages are output from the first positive-side terminal and the second negative-side terminal, the two voltages having same magnitude as the output voltage and being inverted to each other.
